(19) United States
(12) Patent Application Publication
(10) Pub. No.: US 2014/0272486 A1
(43) Pub. Date: Sep. 18, 2014

(54) MOLTEN SALT BATTERY DEVICE AND CONTROL METHOD FOR MOLTEN SALT BATTERY DEVICE

(71) Applicant: SUMITOMO ELECTRIC INDUSTRIES, LTD., Osaka-shi, Osaka (JP)

(72) Inventors: Eiichi Kobayashi, Osaka-shi (JP); Hironobu Saka, Osaka-shi (JP)

(21) Appl. No.: 14/354,448

(22) PCT Filed: Oct. 24, 2012
(86) PCT No.: PCT/JP2012/077396

§ 371 Date: Apr. 25, 2014

(30) Foreign Application Priority Data
Oct. 26, 2011 (JP) 2011-235328

(51) Int. Cl. H01M 10/39; H01M 10/615; H02J 7/00; H01M 10/46

(52) U.S. Cl. CPC H01M 10/399; H01M 10/46; H01M 10/5006; H02J 7/0052; H01M 2220/20; H01M 2300/0048
USPC 429/52; 429/120; 320/107

(57) ABSTRACT

A molten salt battery device includes: a plurality of molten salt battery units; and an auxiliary battery (an electric power source) capable of operating at room temperature. Each molten salt battery unit includes a heater. At the time of startup, the auxiliary battery supplies electric power to the heater of one molten salt battery unit so that the one molten salt battery unit is heated by the heater and thereby allowed to operate. The one molten salt battery unit allowed to operate supplies electric power to the heaters of the other molten salt battery units so that the other molten salt battery units are heated by the heaters and thereby allowed to operate. The molten salt battery is easily heated without the necessity of a large amount of energy and hence the molten salt battery device starts up in a short time.

This application is the national phase under 35 U.S.C. §371 of PCT International Application No. PCT/JP2012/077396 which has an International filing date of Oct. 24, 2012 and designated the United States of America.

### BACKGROUND

1. Technical Field

The present invention relates to: a molten salt battery device provided with a plurality of molten salt batteries; and a control method of operating the molten salt batteries.

2. Description of Related Art

For the purpose of efficient utilization of electric power, batteries having a high energy density and a high efficiency are required. As a battery of such kind, a sodium-sulfur battery disclosed in Japanese Patent Application Laid-Open No. 2007-273297 has been developed. Another example of a battery having a high energy density and a high efficiency is a molten salt battery. The molten salt battery is a battery employing molten salt as electrolyte and operates in a state that the molten salt has been melted. Employable modes of a molten salt battery device storing electric power by using the molten salt battery include a mode of fixed type which is installed in a home or a factory and a mode of non-fixed type which is mounted on an automobile or the like.

### SUMMARY OF THE INVENTION

In order that a molten salt battery should operate stably, the temperature in the inside of the molten salt battery need be maintained at a temperature somewhat higher than the melting point of the molten salt so that the molten salt need be maintained in a liquid state. In general, the melting point of the molten salt is higher than room temperature and hence the molten salt battery operates at a temperature higher than room temperature. Here, the room temperature indicates a temperature in a state that neither heating nor cooling is performed and is, for example, 1° C. to 30° C. or the like. Thus, the molten salt battery device requires a function of heating the molten salt battery. When the molten salt battery device is to be started from a state that the molten salt battery is stopped at a temperature such as room temperature lower than or equal to the melting point of the molten salt, first, the molten salt battery need be heated to a temperature at which the molten salt battery is allowed to operate. An employable method of heating the molten salt battery is a method of heating the molten salt battery by using a heater. Nevertheless, at the time of startup, the molten salt battery itself is not allowed to serve as a power supply for the heater. In particular, the molten salt battery device of non-fixed type has a problem of difficulty in supplying energy from the outside for the purpose of heating the molten salt battery.

Further, a certain amount of time is necessary for heating the molten salt battery to a temperature at which the molten salt battery is allowed to operate. Thus, a warm-up time occurs until the molten salt battery device becomes usable at the time of startup. In particular, when the size of the molten salt battery is increased for the purpose of increasing the capacity, a problem arises that the warm-up time increases. Further, for the purpose of improving the efficiency of energy utilization, energy consumption for heating the molten salt battery need be reduced.

The present invention has been devised in view of such situations. An object thereof is to provide: a molten salt battery device in which the molten salt battery is heated easily and the warm-up time at the time of startup is reduced so that energy necessary for heating the molten salt battery is reduced; and a control method for molten salt battery device.

A molten salt battery device is characterized by comprising: a plurality of molten salt batteries operating in a state that molten salt serving as electrolyte is melted at a temperature higher than room temperature; heaters each provided in each of the plurality of molten salt batteries; an electric power source for supplying electric power at room temperature to the heaters provided in a part of the plurality of molten salt batteries; and an electric power supplying unit for supplying electric power from the part of the plurality of molten salt batteries, to the heaters provided in another part of the plurality of molten salt batteries.

The molten salt battery device according to the present invention is characterized in that the electric power supplying unit supplies electric power in a chained manner from the molten salt battery heated by the heaters to which electric power is supplied, to the heaters provided in another part of the plurality of molten salt batteries.

The molten salt battery device according to the present invention is characterized in that the electric power supplying unit includes an adjusting unit for adjusting the number of heaters to which electric power is to be supplied.

The molten salt battery device according to the present invention is characterized by further comprising: an electric power providing unit for providing the outside with electric power from a part or all of the plurality of molten salt batteries; and a receiving unit for receiving information indicating demand for electric power to be provided to the outside by the electric power providing unit, wherein the adjusting unit adjusts the number of heaters to which electric power is to be supplied, in accordance with the information.

The molten salt battery device according to the present invention is characterized by further comprising: a first electric power providing unit for providing the outside with electric power from a part or all of the plurality of molten salt batteries; and a second electric power providing unit for providing the outside with electric power from the electric power source.

The molten salt battery device according to the present invention is characterized in that the electric power source is a rechargeable battery capable of operating at room temperature.

The molten salt battery device according to the present invention is characterized in that the electric power source is a capacitor.

The molten salt battery device according to the present invention is characterized by further comprising: a first charging unit for charging the electric power source with electric power supplied from the outside; and a second charging unit for discharging the electric power source and thereby charging a part or all of the plurality of molten salt batteries with the electric power having been charged in the electric power source.

The molten salt battery device according to the present invention is characterized by further comprising: a first charging unit for charging the electric power source with electric power supplied from the outside; and a second charging unit for discharging the electric power source and thereby charging a part or all of the plurality of molten salt batteries with the electric power having been charged in the electric power source.

A control method for controlling a molten salt battery device comprising: a plurality of molten salt batteries operating in a state that molten salt serving as electrolyte is melted at a temperature higher than room temperature; heaters each heating each molten salt battery; and an electric power source capable of operating at room temperature, is characterized by comprising the steps of: supplying electric power from the electric power source to the heaters heating a part of the plurality of molten salt batteries in a state that a temperature of the plurality of molten salt batteries is at room temperature; and supplying electric power from the molten salt battery which has been heated by the heaters so that the molten salt has been melted to the heaters heating another part of the plurality of molten salt batteries.

The control method for molten salt battery device according to the present invention is characterized by further comprising the steps of: receiving information indicating demand for electric power to be provided from the molten salt battery device to the outside; and adjusting the number of molten salt batteries in which electric power is to be supplied to the heaters among the plurality of molten salt batteries, in accordance with the information.

In the present invention, in the molten salt battery device provided with a plurality of molten salt batteries and with an electric power source capable of operating at room temperature, a part of the plurality of molten salt batteries are heated at room temperature with electric power from the electric power source so that the part of the plurality of molten salt batteries are caused to operate. Then, the other molten salt batteries are heated with the electric power from the part of the plurality of molten salt batteries which are operating. The molten salt battery device is allowed to start up from a state that the temperature is at room temperature.

Further, in the present invention, the molten salt battery heated with the electric power from the electric power source supply electric power to heaters and thereby heat another part of the plurality of molten salt batteries. Then, the molten salt battery having been heated heat yet another part of the plurality of molten salt batteries. As such, the molten salt batteries are heated in a chained manner.

Further, in the present invention, in the molten salt battery device, among the plurality of molten salt batteries, the number of molten salt batteries to be heated and caused to operate is adjusted in accordance with the electric power demand. When the electric power demand is low, the number of molten salt batteries to be heated is reduced and hence energy consumption necessary for the heating is reduced.

Further, in the present invention, the molten salt battery device includes a rechargeable battery as an electric power source. First, the rechargeable battery is started at room temperature and then the molten salt batteries are allowed to start up. The rechargeable battery is allowed to be charged when electric power is supplied from the outside.

Further, in the present invention, the molten salt battery device includes a capacitor as an electric power source. First, the capacitor is started at room temperature and then the molten salt batteries are allowed to start up. The capacitor is allowed to be charged when electric power is supplied from the outside of the molten salt battery device.

Further, in the present invention, in the molten salt battery device, the rechargeable battery or the capacitor serving as an electric power source is charged with electric power supplied from the outside. After that, the rechargeable battery or the capacitor is caused to be discharged and thereby re-charge the molten salt batteries. When the rechargeable battery or the capacitor in which charge and discharge are achieved at higher speeds than the molten salt batteries is used, charging is achieved efficiently.

Further, in the present invention, the molten salt battery device is allowed to provide the outside with electric power from the rechargeable battery or the capacitor employed as an electric power source. Thus, the molten salt battery device is allowed to provide electric power at the time of startup even at a stage that the molten salt battery is not yet allowed to operate.

In the present invention, in the molten salt battery device, even in a state that the temperature is at room temperature, by causing the electric power source to operate, the molten salt batteries are allowed to be heated and started easily. Further, the electric power from the electric power source is used for heating a part of the plurality of molten salt batteries, energy consumption for heating the molten salt batteries is reduced. Further, when other molten salt batteries are heated with the electric power from the molten salt batteries having been heated, the present invention provides excellent effects like that the time necessary for heating the plurality of molten salt batteries is allowed to be reduced and then the warm-up time necessary for startup of the molten salt battery device is allowed to be reduced.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram illustrating a mode of utilization of a molten salt battery device according to Embodiment 1;

FIG. 2 is a block diagram illustrating an electrical configuration of a molten salt battery device according to Embodiment 1;

FIG. 3 is a schematic perspective view illustrating an exemplary configuration of a molten salt battery unit;

FIG. 4 is a schematic perspective view illustrating an internal configuration of a molten salt battery cell;

FIG. 5 is a block diagram illustrating an electrical configuration of a molten salt battery device according to Embodiment 2;

FIG. 6 is a schematic sectional view illustrating a configuration of a capacitor; and

FIG. 7 is a block diagram illustrating an electrical configuration of a molten salt battery device according to Embodiment 3.

### DETAILED DESCRIPTION

Hereinafter, the present invention is described specifically with reference to the drawings illustrating embodiments.

### Embodiment 1

FIG. 1 is a schematic diagram illustrating a mode of utilization of a molten salt battery device according to Embodiment 1. The molten salt battery device 1 is an electric power storage device of car-mounted type and is mounted on an automobile 2. For example, the automobile 2 is an electric car or a hybrid car. The molten salt battery device 1 is connected through a signal line to an operation unit 21 operated by a user for inputting an instruction such as an instruction of operation start. Further, the molten salt battery device 1 is connected through a power line to a load 22 such as a motor mounted on the automobile 2.

FIG. 2 is a block diagram illustrating the electrical configuration of the molten salt battery device 1 according to Embodiment 1. The molten salt battery device 1 includes: a plurality of molten salt battery units 3, 3 . . . ; and an auxiliary battery 41 capable of operating at room temperature. The plurality of molten salt battery units 3, 3 . . . and the auxiliary battery 41 are connected to through a power line a receive/provide circuit 42 receiving and providing electric power relative to the outside. The receive/provide circuit 42 is connected to a load 22 not illustrated in FIG. 2. Further, the receive/provide circuit 42 is connected to an electric power supplying circuit 43 supplying electric power for heating to the molten salt battery units 3, 3 . . . . The electric power supplying circuit 43 is connected through power lines to the molten salt battery units 3, 3 . . . . Further, the molten salt battery device 1 includes a control unit 44 controlling the operation of the molten salt battery device 1 and the control unit 44 is connected to the receive/provide circuit 42. Further, the control unit 44 is connected to: a signal receiving unit 45 which receives a signal from the operation unit 21; and a temperature sensor 46 measuring the temperature of each of the molten salt battery units 3, 3 . . . . Further, although not illustrated in FIG. 2, the control unit 44 is connected also to the electric power supplying circuit 43.

FIG. 3 is a schematic perspective view illustrating an exemplary configuration of the molten salt battery unit 3. The molten salt battery unit 3 is constructed from: a plurality of molten salt battery cells 31, 31 . . . ; and a plurality of heaters 32, 32 . . . heating the molten salt battery cells 31, 31 . . . . In the example illustrated in FIG. 3, four molten salt battery cells 31 are aligned in straight line and connected in series to each other. Further, nine rows each composed of four molten salt battery cells 31 connected in series to each other are aligned in parallel to each other and connected in parallel to each other. That is, the molten salt battery unit 3 contains 36 molten salt battery cells 31. The two poles of the plurality of molten salt battery cells 31 connected to each other are connected to the receive/provide circuit 42.

A rectangular plate-shaped heater 32 is arranged at each of both ends of the nine rows each composed of four molten salt battery cells 31. The heater 32 is arranged in contact with the side surface of the molten salt battery cell 31. Further, a heater 32 is arranged between the third row and the fourth row and a heater 32 is arranged also between the sixth row and the seventh row. That is, the molten salt battery unit 3 includes four heaters 32 and the heaters 32 are respectively in contact with the molten salt battery cells 31 located at the first row, the third row, the fourth row, the sixth row, the seventh row, and the ninth row. Each heater 32 is connected to the electric power supplying circuit 43. The heaters 32, 32 . . . are electric heaters such as rubber heaters and ceramic heaters generating heat when electric power is supplied. When electric power is supplied from the electric power supplying circuit 43, the heaters 32, 32 . . . generate heat and thereby heat the molten salt battery cells 31, 31 . . . in the molten salt battery unit 3. The entirety of the molten salt battery unit 3 is covered by a heat insulating material 33. In FIG. 3, the outer shape of the heat insulating material 33 is illustrated by a dashed line. Here, the arrangement and the connection mode of the plurality of molten salt battery cells 31 and the arrangement of the plurality of heaters 32 illustrated in FIG. 3 are merely an example. That is, the arrangement and the connection mode of the plurality of molten salt battery cells 31 and the arrangement of the plurality of heaters 32 may be in any other mode.

FIG. 4 is a schematic perspective view illustrating the internal configuration of the molten salt battery cell 31. The molten salt battery cell 31 is constructed such that a plurality of positive electrodes 311, 311 . . . and negative electrodes 312, 312 . . . formed in a rectangular plate shape are stacked alternately in the inside of a battery container 316 having a rectangular parallelepiped box shape and then a sheet-shaped separator 313 is arranged between each positive electrode 311 and each negative electrode 312. In FIG. 4, the outer shape of the battery container 316 is indicated by a dashed line. The positive electrodes 311, 311 . . . , the negative electrodes 312, 312 . . . , and the separators 313, 313 . . . are arranged in a perpendicular orientation relative to the bottom face of the battery container 316.

The positive electrodes 311, 311 . . . are formed such that positive-electrode material containing positive-electrode active material such as NaCrO₂ is coated on a charge collector having a rectangular plate shape. The negative electrodes 312, 312 . . . are formed such that negative-electrode material containing negative-electrode active material such as Sn (tin) is formed by plating on a charge collector having a rectangular plate shape. The separators 313, 313 . . . are formed from insulating material such as silicate glass or resin in a shape that electrolyte is allowed to be held in the inside and that ions serving as carriers of electric charge are allowed to pass through. For example, the separators 313, 313 . . . are glass cloth or porous shaped resin. Each separator 313 is arranged such as to separate the positive electrode 311 and the negative electrode 312 from each other. The positive electrodes 311, 311 . . . , the negative electrodes 312, 312 . . . , and the separators 313, 313 . . . are impregnated with electrolyte composed of molten salt.

The electrolyte is a molten salt serving as electrically conductive liquid in a molten state. In order that the melting point should be reduced, it is preferable that the electrolyte is a mixture of plural kinds of molten salts. For example, the electrolyte is a mixed salt composed of NaFSA containing sodium ions serving as cations and FSA (bisfluorosulfonylamide) serving as anions and of KFSA containing potassium ions serving as cations and FSA serving as anions. Here, the molten salt serving as electrolyte may contain any other anions such as TFSA (bistrifluoromethylsulfonylamide) or FTA (fluorotrifluoromethylsulfonylamide), and alternatively may contain any other cations such as organic ions.

The positive electrodes 311, 311 . . . are connected to a connection member 314 for positive electrodes fabricated from conducting material and the negative electrodes 312, 312 . . . are connected to a connection member 315 for negative electrodes fabricated from conducting material. Each of the connection member 314 for positive electrodes and the connection member 315 for negative electrodes is connected to a terminal (not illustrated) used for charge and discharge in the molten salt battery cell 31. Each terminal is connected to another molten salt battery cell 31 or the receive/provide circuit 42. Here, the configuration of the molten salt battery cell 31 illustrated in FIG. 4 is of schematic configuration. Thus, the inside of the molten salt battery cell 31 may include other constituents (not illustrated) like an elastic member suppressing deformation in the positive electrodes 311, 311 . . . and the negative electrodes 312, 312 . . . at the time of charge and discharge. Further, FIG. 4 illustrates a mode that the negative electrodes 312 are provided in a number equal to the number of the positive electrodes 311 plus one. Instead, the negative electrodes 312 and the positive electrodes 311 may be in the same number, or alternatively the positive electrodes 311 may be in a number greater than the number of the negative electrodes 312. Further, the molten salt battery cell 31 may be in a mode that a pair of the positive electrode 311 and the negative electrode 312 is provided. Further, the shape of the molten salt battery cell 31 is not limited to a rectangular parallelepiped shape and may be any other shape such as a cylindrical shape.

The auxiliary battery 41 is a rechargeable battery such as a lead-acid battery and a lithium-ion rechargeable battery capable of operating at room temperature. The auxiliary battery 41 serves as an electric power source in the present invention. The capacity of the auxiliary battery 41 is smaller than the capacity of the molten salt battery unit 3. The receive/provide circuit 42 is a circuit providing electric power to the load 22 with adjusting the current and the voltage discharged from the molten salt battery units 3, 3 . . . . Further, the receive/provide circuit 42 is allowed to receive electric power from the load 22 or an external electric power source (not illustrated) and then charge the molten salt battery units 3, 3 . . . and the auxiliary battery 41 with the received electric power. Further, the receive/provide circuit 42 is allowed to supply to the electric power supplying circuit 43 the electric power from the auxiliary battery 41 or the molten salt battery units 3, 3 . . . . The electric power supplying circuit 43 supplies the supplied electric power to the molten salt battery units 3, 3 . . . .

The control unit 44 is an electronic circuit constructed from: an arithmetic operation unit performing arithmetic operation; and a memory storing various kinds of data and programs. The signal receiving unit 45 is an interface connected to the operation unit 21 and receives a signal indicating an instruction such as an instruction of operation start input through the operation unit 21. In accordance with the instruction input to the signal receiving unit 45, the control unit 44 controls the auxiliary battery 41, the receive/provide circuit 42, and the electric power supplying circuit 43. For example, when an instruction of operation start is input to the signal receiving unit 45, the control unit 44 causes electric power to be supplied from the auxiliary battery 41 through the receive/provide circuit 42 to the electric power supplying circuit 43 and then causes the electric power supplying circuit 43 to supply the electric power to one molten salt battery unit 3. The electric power supplied from the electric power supplying circuit 43 is supplied to the heaters 32, 32 . . . in the inside of the molten salt battery unit 3. The temperature sensor 46 is constructed from a thermistor, a thermocouple, or the like and arranged in the inner side of the heat insulating material 33 of the molten salt battery unit 3. On the basis of the temperature in the inside of the molten salt battery unit 3 measured by the temperature sensor 46, the control unit 44 performs the processing of adjusting the electric power supplied from the electric power supplying circuit 43 to the molten salt battery unit 3 and thereby controlling the temperature of the molten salt battery cells 31, 31 . . . .

Next, the operation of the molten salt battery device 1 is described below. During the time that the molten salt battery device 1 is operating like the time that the automobile 2 is moving, the molten salt battery units 3, 3 . . . are discharged and a part of the electric power generated by discharge is supplied to the molten salt battery units 3, 3 . . . through the electric power supplying circuit 43. The supplied electric power is supplied to the heaters 32, 32 . . . in the inside of each molten salt battery unit 3 and then the heaters 32, 32 . . . heat the molten salt battery cells 31, 31 . . . . On the basis of the temperature measured by the temperature sensor 46, the control unit 44 controls the electric power supplied from the electric power supplying circuit 43, in such a manner that the temperature in the inside of the molten salt battery unit 3 should be maintained at a temperature at which the molten salt in the molten salt battery cell 31 is melted and the molten salt battery cell 31 operates stably. The receive/provide circuit 42 provides the load 22 with the electric power from the molten salt battery units 3, 3 . . . . Further, suitably, the receive/provide circuit 42 receives regenerated electric power from the load 22 or alternatively electric power supplied from an external electric power source (not illustrated) in the outside of the automobile 2, and thereby charges the auxiliary battery 41 and the molten salt battery units 3, 3 . . . .

When the molten salt battery device 1 is stopped like in a case that the automobile 2 is parked, the charge and discharge of the molten salt battery units 3, 3 . . . is stopped and the electric power supply from the electric power supplying circuit 43 is also stopped. The heaters 32, 32 . . . in the molten salt battery unit 3 stop heating and hence the temperature of the molten salt battery cells 31, 31 . . . falls to room temperature below the melting point of the molten salt. After the temperature of the molten salt battery cells 31, 31 . . . has fallen to room temperature, the molten salt is solidified and becomes an insulator so that the molten salt battery unit 3 becomes not allowed to operate. The auxiliary battery 41 is in a state of having been charged.

Like in a case that the automobile 2 is to be started, when the molten salt battery device 1 is to be started from a stopped state, the user operates the operation unit 21 and thereby inputs a start instruction. Then, the signal receiving unit 45 receives the start instruction from the operation unit 21. In accordance with the start instruction received by the signal receiving unit 45, the control unit 44 causes the auxiliary battery 41 to start discharge. Further, the control unit 44 causes the receive/provide circuit 42 to supply to the electric power supplying circuit 43 the electric power from the auxiliary battery 41 and then causes the electric power supplying circuit 43 to supply the electric power to one molten salt battery unit 3. The one molten salt battery unit 3 serving as a target to which the electric power is to be supplied is set forth in advance. Then, information indicating the target to which the electric power is to be supplied is stored in advance in the control unit 44. Here, the one molten salt battery unit 3 to which the electric power from the auxiliary battery 41 is to be supplied may be changed suitably. In the molten salt battery unit 3 to which the electric power is supplied, the heaters 32, 32 . . . generate heat so as to heat the molten salt battery cells 31, 31 . . . . On the basis of the temperature measured by the temperature sensor 46, the control unit 44 causes the molten salt battery unit 3 to be heated to a temperature at which the molten salt is melted and the molten salt battery cells 31, 31 . . . operate stably. In the state that the molten salt in the molten salt battery cells 31, 31 . . . is melted into electrolytic solution, the one molten salt battery unit 3 to which the electric power has been supplied becomes allowed to operate.

Then, the control unit 44 causes the allowed-to-operate molten salt battery unit 3 to start discharge. Further, the control unit 44 causes the receive/provide circuit 42 to supply to the electric power supplying circuit 43 the electric power from the molten salt battery unit 3 and then causes the electric power supplying circuit 43 to supply the electric power to the other molten salt battery units 3, 3 . . . . In the molten salt battery units 3, 3 . . . to which the electric power has been supplied, the heaters 32, 32 . . . heat the molten salt battery cells 31, 31 . . . and then, in a state that the molten salt is melted into electrolytic solution, the molten salt battery units 3, 3 . . . become allowed to operate. That is, in the present embodiment, the one molten salt battery unit 3 is heated with the electric power from the auxiliary battery 41 and then the other molten salt battery units 3, 3 . . . are heated with the electric power from the one molten salt battery unit 3 having become allowed to operate. As such, the receive/provide circuit 42, the electric power supplying circuit 43, and the control unit 44 serve as the electric power supplying means in the present invention. At the stage that all molten salt battery units 3 have become allowed to operate, startup of the molten salt battery device 1 is completed. After that, the control unit 44 causes the molten salt battery units 3, 3 . . . to be charged and discharged and causes the receive/provide circuit 42 to receive and provide electric power.

As described above in detail, in the present embodiment, the molten salt battery device 1 includes the auxiliary battery 41 capable of operating at room temperature. Then, at the time of startup, electric power is supplied from the auxiliary battery 41 to one molten salt battery unit 3 so that the one molten salt battery unit 3 is heated and allowed to operate. The one molten salt battery unit 3 allowed to operate supplies electric power to the other molten salt battery units 3, 3 . . . and thereby heats and allows the other molten salt battery units 3, 3 . . . to operate. The auxiliary battery 41 is a battery capable of operating even at room temperature. Thus, even in a state that the temperature is at room temperature, the molten salt battery device 1 is allowed to start up by causing the auxiliary battery 41 to be discharged. Thus, according to the present invention, the molten salt battery is easily heated so that the molten salt battery device 1 is allowed to start up. In particular, the molten salt battery device 1 of non-fixed type is allowed to be realized.

Further, the electric power from the auxiliary battery 41 is merely for heating one molten salt battery unit 3 alone. Thus, in comparison with a case of heating all molten salt battery units 3, 3 . . . , energy consumption for heating the molten salt batteries is allowed to be reduced. It is sufficient that the capacity of the auxiliary battery 41 is a capacity enough for heating one molten salt battery unit 3. Thus, the capacity of the auxiliary battery 41 is allowed to be reduced and hence size reduction and weight reduction of the molten salt battery device 1 is achieved. Further, the capacity of the molten salt battery unit 3 is larger than the auxiliary battery 41. Thus, the large electric power is supplied to the other molten salt battery units 3, 3 . . . , and the molten salt battery units 3, 3 . . . are allowed to be heated more efficiently in comparison with a case that electric power is supplied from the auxiliary battery 41 to all molten salt battery units 3, 3 . . . . Thus, the time necessary for heating the molten salt battery units 3, 3 . . . is allowed to be reduced and hence the warm-up time necessary for startup of the molten salt battery device 1 is allowed to be reduced.

Here, the molten salt battery device 1 is not limited to a mode that electric power is supplied from one molten salt battery unit 3 to which the electric power has been supplied from the auxiliary battery 41, to the other molten salt battery units 3, 3 . . . . That is, the molten salt battery device 1 may be in a mode that the number of molten salt battery units 3, 3 . . . to which electric power is to be supplied from the one molten salt battery unit 3 allowed to operate is allowed to be adjusted. For example, the automobile 2 includes a sensor detecting electric power necessary for the load 22 and then information indicating the electric power demand is input from the sensor to the signal receiving unit 45. Further, for example, information concerning running such as the scheduled travel distance and the number of passengers is input to the operation unit 21 and then information indicating the electric power demand corresponding to the input information is input to the signal receiving unit 45. In accordance with the electric power demand indicated by the information input to the signal receiving unit 45, the control unit 44 performs the processing of adjusting the number of molten salt battery units 3, 3 . . . to which electric power is to be supplied from one molten salt battery unit 3 having become allowed to operate. As a result of this processing, the number of molten salt battery units 3, 3 . . . to be caused to operate is adjusted. The control unit 44 adjusts the number of molten salt battery units 3, 3 . . . to be caused to operate, per unit. For example, when the electric power demand is below a setting value set forth in advance, the control unit 44 causes the electric power supplying circuit 43 to supply the electric power from the one molten salt battery unit 3 to a part of the other molten salt battery units 3, 3 . . . . The molten salt battery units 3 to which the electric power has been supplied operate and the molten salt battery units 3 to which the electric power is not supplied do not operate. That is, in this mode, when the necessary electric power is low, a part of the molten salt battery units 3, 3 . . . operate. When the electric power demand is low, a small number of molten salt battery units 3 are to be heated and hence energy consumption for heating the molten salt batteries is reduced further. Further, in a case that the electric power from one molten salt battery unit 3 is to be supplied to a small number of molten salt battery units 3, the electric power supplied to each molten salt battery unit 3 becomes large. Thus, the temperature in the inside of the molten salt battery unit 3 rises more rapidly. Thus, the warm-up time necessary for startup of the molten salt battery device 1 is allowed to be reduced further.

Further, the molten salt battery device 1 may be in a mode that each of the molten salt battery units 3, 3 . . . supplies electric power in a chained manner. Specifically, a molten salt battery unit 3 to which the electric power has been supplied from the auxiliary battery 41 supplies electric power to one of the other molten salt battery units 3, 3 . . . . Then, the molten salt battery unit 3 to which the electric power has been supplied supplies electric power further to the next one molten salt battery unit 3. In this mode, power consumption for heating the molten salt battery units 3, 3 . . . is allowed to be distributed to each molten salt battery unit 3. Further, in this mode, it is easy to adjust the number of molten salt battery units 3, 3 . . . to be caused to operate in accordance with the electric power demand.

Further, the molten salt battery device 1 is not limited to a mode of being started after all molten salt battery units 3, 3 . . . have become allowed to operate. That is, a mode may be employed that startup is performed at the stage that the one molten salt battery unit 3 has become allowed to operate. In this mode, the control unit 44 causes the electric power from the one molten salt battery unit 3 to which electric power has been supplied from the auxiliary battery 41, to be supplied to the other molten salt battery units 3, 3 . . . and, at the same time, causes the electric power from the one molten salt battery unit 3 to be provided by the receive/provide circuit 42 to the load 22. At the stage that the one molten salt battery unit 3 to which the electric power has been supplied from the auxiliary battery 41 has become allowed to operate, before the other molten salt battery units 3, 3 . . . become allowed to operate, the molten salt battery device 1 starts up so as to provide electric power. After the other molten salt battery units 3, 3 . . . have become allowed to operate, the molten salt battery device 1 receives and provides electric power by using the plurality of molten salt battery units 3, 3 . . . . At the stage that the one molten salt battery unit 3 has become allowed to operate, the molten salt battery device 1 starts up. Thus, the warm-up time necessary for startup of the molten salt battery device 1 is allowed to be reduced further.

Further, the molten salt battery device 1 may be in a mode that the electric power from the auxiliary battery 41 is allowed to be provided by the receive/provide circuit 42 to the load 22. In this mode, the receive/provide circuit 42 is allowed to provide the load 22 with electric power in a manner of adjusting the current and the voltage discharged from the auxiliary battery 41. Thus, depending on the necessity, the control unit 44 causes the receive/provide circuit 42 to provide the load 22 with the electric power from the auxiliary battery 41. For example, even at the stage that the molten salt battery units 3, 3 . . . are not yet allowed to operate, the molten salt battery device 1 is allowed to provide the load 22 with the electric power from the auxiliary battery 41 so as to cause the load 22 to operate. At that time, the molten salt battery device 1 starts up before the molten salt battery units 3, 3 . . . become allowed to operate. After the molten salt battery units 3, 3 . . . have become allowed to operate, the molten salt battery device 1 receives and provides electric power by using the molten salt battery units 3, 3 . . . . Thus, in this mode, the warm-up time necessary for startup of the molten salt battery device 1 is allowed to be reduced in appearance. Further, it is allowed to reduce the startup time in which the load 22 is caused to operate so that the automobile 2 is started.

Further, the present embodiment has been described for a mode that electric power is supplied from the auxiliary battery 41 through the receive/provide circuit 42 and the electric power supplying circuit 43 to the molten salt battery unit 3. Instead, the molten salt battery device 1 may be in a mode that the auxiliary battery 41 is connected directly to one molten salt battery unit 3. Further, the molten salt battery device 1 may be in a mode that the molten salt battery unit 3 to which electric power is to be supplied from the auxiliary battery 41 is connected directly to the other molten salt battery units 3, 3 . . . . Further, the present embodiment has been described for a mode that electric power is supplied from the auxiliary battery 41 to one molten salt battery unit 3. Instead, the molten salt battery device 1 may be in a mode that electric power is supplied from the auxiliary battery 41 to several molten salt battery units 3.

### Embodiment 2

FIG. 5 is a block diagram illustrating the electrical configuration of a molten salt battery device 1 according to Embodiment 2. In Embodiment 2, the molten salt battery device 1 includes a capacitor 5 in place of the auxiliary battery 41 in Embodiment 1. The capacitor 5 is connected to the receive/provide circuit 42 through a power line. Then, the capacitor 5 supplies electric power to one molten salt battery unit 3 through the receive/provide circuit 42 and the electric power supplying circuit 43. The receive/provide circuit 42 is allowed to receive electric power from the load 22 or an external electric power source (not illustrated) and then charge the capacitor 5 with the supplied electric power. Further, the receive/provide circuit 42 adjusts the current and the voltage discharged from the capacitor 5, and is allowed to provide the electric power from the capacitor 5, to the load 22 in the outside of the molten salt battery device 1. Further, the control unit 44 is connected to the capacitor 5 and controls the operation of the capacitor 5. The other points in the configuration of the molten salt battery device 1 are similarly to those in Embodiment 1. Thus, corresponding parts are designated by like numerals and their description is omitted.

FIG. 6 is a schematic sectional view illustrating the configuration of the capacitor 5. The capacitor 5 has a structure that a positive electrode layer 52 and a negative electrode layer 54 having plate shapes are stacked with a separator 53 inserted in between. Further, a positive electrode substrate 51 is provided in the outer side of the positive electrode layer 52 and a negative electrode substrate 55 is provided in the outer side of the negative electrode layer 54. The positive electrode substrate 51 and the negative electrode substrate 55 are metal plates such as stainless steel plates. Each of the positive electrode layer 52 and the negative electrode layer 54 has a structure that electrically conductive active material is adhered to a plate-shaped porous metal body. The porous metal body is a metal porous medium that is fabricated by plating metal onto a sponge-like porous resin and then removing the porous resin and that has a three-dimensional network structure. For example, the porous metal body used for the positive electrode layer 52 and the negative electrode layer 54 is an aluminum porous body or a nickel porous body. When the porous metal body is employed for the positive electrode layer 52 and the negative electrode layer 54, the capacitor 5 acquires a higher power density.

For example, the electrically conductive active material contained in the positive electrode layer 52 and the negative electrode layer 54 is carbon powder. The separator 53 is porous resin formed in a sheet shape. For example, the material of the separator 53 is polyethylene. The positive electrode layer 52, the separator 53, and the negative electrode layer 54 are impregnated with electrolyte which is in liquid form at the operating temperature of the capacitor 5. For example, the electrolyte is propylene carbonate in which LiPF₆ is dissolved. The capacitor 5 serves as an electric double layer capacitor when a voltage is applied between the positive electrode layer 52 and the negative electrode layer 54. Here, the structure of the capacitor 5 may be of a multilayer structure that a plurality of positive electrode layers 52 and negative electrode layers 54 are stacked with separators 53 in between. Further, in place of the multilayer structure, the structure of the capacitor 5 may be of a structure that the positive electrode layer 52, the separator 53, and the negative electrode layer 54 having sheet shapes are wound in a cylindrical shape.

Next, the operation of the molten salt battery device 1 is described below. When the molten salt battery device 1 is operating like in a case that the automobile 2 is moving, the temperature in each molten salt battery unit 3 is maintained at a temperature at which the molten salt serving as electrolyte is melted so that the molten salt battery cell 31 operates stably. The molten salt battery units 3, 3 . . . are charged and discharged through the receive/provide circuit 42. Similarly, the capacitor 5 is charged and discharged through the receive/provide circuit 42. The capacitor 5 is allowed to be charged and discharged at higher speeds than the molten salt battery cell 31. Thus, the control unit 44 performs the processing of causing the capacitor 5 to execute short-cycle charge and discharge and causing the molten salt battery units 3, 3 . . . to execute longer-cycle charge and discharge. Further, when temporary and high current charging is necessary, the control unit 44 performs the processing of causing the capacitor 5 to be charged. For example, when large electric power is supplied from the load 22 to the receive/provide circuit 42 like in a case that regenerated electric power is generated in accordance with deceleration of the automobile 2, the control unit 44 performs the processing of charging the capacitor 5 with the electric power supplied to the receive/provide circuit 42. Further, the control unit 44 performs the processing of causing the charged capacitor 5 to be discharged and causing the receive/provide circuit 42 to charge the molten salt battery units 3, 3 . . . with the electric power discharged from the capacitor 5. This processing allows temporary and large electric power such as regenerated electric power to be efficiently charged into the molten salt battery device 1.

After the molten salt battery device 1 is stopped like in a case that the automobile 2 has been parked, the temperature of the molten salt battery units 3, 3 . . . falls to room temperature and hence the molten salt battery units 3, 3 . . . become not allowed to operate. The capacitor 5 is in a state of having been charged.

Like in a case that the automobile 2 is to be started, when the molten salt battery device 1 is to be started from a stopped state, a start instruction is input to the signal receiving unit 45 and then the control unit 44 causes the capacitor 5 to start supplying of electric power to one molten salt battery unit 3. As such, the capacitor 5 serves as an electric power source in the present invention. The molten salt battery unit 3 to which electric power has been supplied from the capacitor 5 is heated by the heaters 32, 32 . . . so that the molten salt in the molten salt battery cells 31, 31 . . . is melted into electrolytic solution, and hence the molten salt battery unit 3 is allowed to operate. Then, the control unit 44 causes the allowed-to-operate molten salt battery unit 3 to supply electric power to the other molten salt battery units 3, 3 . . . . The other molten salt battery units 3, 3 . . . are heated and thereby allowed to operate. Then, at the stage that all molten salt battery units 3 have become allowed to operate, startup of the molten salt battery device 1 is completed. After that, the control unit 44 causes the capacitor 5 and the molten salt battery units 3, 3 . . . to be charged and discharged and causes the receive/provide circuit 42 to receive and provide the electric power.

As described above in detail, in the present embodiment, the molten salt battery device 1 includes the capacitor 5. Then, one molten salt battery unit 3 is heated with the electric power from the capacitor 5. Then, the other molten salt battery units 3, 3 . . . are heated with the electric power from the one molten salt battery unit 3 having become allowed to operate. The capacitor 5 is capable of operating even at room temperature. Thus, even in a state that the temperature is at room temperature, the molten salt battery device 1 is allowed to start up by causing the capacitor 5 to be discharged. Thus, also in the present embodiment, the molten salt battery is allowed to be easily heated and hence the molten salt battery device 1 is allowed to easily start up. Further, the electric power from the capacitor 5 is merely for heating one molten salt battery unit 3 alone. Thus, energy consumption for heating the molten salt batteries is allowed to be reduced. Further, similarly to Embodiment 1, the time necessary for heating the molten salt battery units 3, 3 . . . is allowed to be reduced and hence the warm-up time necessary for startup of the molten salt battery device 1 is allowed to be reduced. Further, in the present embodiment, when the capacitor 5 is charged with electric power from the outside and discharged, this allows temporary and large electric power such as regenerated electric power to be efficiently charged into the molten salt battery device 1.

Here, similarly to Embodiment 1, the molten salt battery device 1 may be in a mode adjusting the number of target molten salt battery units 3, 3 . . . to which electric power is to be supplied from the one molten salt battery unit 3 allowed to operate. Further, the molten salt battery device 1 may be in a mode that each of the molten salt battery units 3, 3 . . . supplies electric power in a chained manner. Further, similarly to Embodiment 1, the molten salt battery device 1 may be in a mode that startup is performed at the stage that the one molten salt battery unit 3 has become allowed to operate.

Further, the molten salt battery device 1 may be in a mode that the electric power from the capacitor 5 is allowed to be provided by the receive/provide circuit 42 to the load 22. In this mode, the receive/provide circuit 42 is allowed to provide the load 22 with electric power in a manner of adjusting the current and the voltage discharged from the capacitor 5. Thus, depending on the necessity, the control unit 44 causes the receive/provide circuit 42 to provide the load 22 with the electric power from the capacitor 5. For example, even at the stage that the molten salt battery units 3, 3 . . . are not yet allowed to operate, the molten salt battery device 1 is allowed to provide the load 22 with the electric power from the capacitor 5 so as to cause the load 22 to operate. After the molten salt battery units 3, 3 . . . have become allowed to operate, the molten salt battery device 1 receives and provides electric power by using the molten salt battery units 3, 3 . . . . Thus, in this mode, the warm-up time necessary for startup of the molten salt battery device 1 is allowed to be reduced in appearance. Further, it is allowed to reduce the startup time in which the load 22 is caused to operate so that the automobile 2 is started.

Further, the molten salt battery device 1 may be in a mode that electric power is supplied from the capacitor 5 to the plurality of molten salt battery units 3. Further, the molten salt battery device 1 may be in a mode that the capacitor 5 is connected directly to one molten salt battery unit 3.

Further, the molten salt battery device 1 may be in a mode that in place of the capacitor 5, a rechargeable battery is employed that is allowed to be charged and discharged at higher speeds than the molten salt battery. In this mode, the rechargeable battery operates similarly to the capacitor 5. When large electric power is supplied to the receive/provide circuit 42, the molten salt battery device 1 is allowed to cause the rechargeable battery to be charged, then cause the charged rechargeable battery to be discharged, and then cause the molten salt battery units 3, 3 . . . to be charged with the discharged electric power. Thus, also in this mode, temporary and large electric power is allowed to be efficiently charged into the molten salt battery device 1.

### Embodiment 3

Embodiments 1 and 2 have been described for a mode that the molten salt battery device 1 is of non-fixed type. In Embodiment 3 is described for a mode of fixed type. FIG. 7 is a block diagram illustrating the electrical configuration of a molten salt battery device 1 according to Embodiment 3. In Embodiment 3, the molten salt battery device 1 does not include the auxiliary battery 41 in Embodiment 1. Further, the receive/provide circuit 42 is connected to an external electric power source 47 such as a commercial electric power source separately from the external load. The receive/provide circuit 42 supplies the electric power provided from the external electric power source 47 to the electric power supplying circuit 43. Then, the electric power supplying circuit 43 supplies the supplied electric power to one molten salt battery unit 3. In the present embodiment, the external electric power source 47 serves as an electric power source in the present invention. The other points in the configuration of the molten salt battery device 1 are similarly to those in Embodiment 1. Thus, corresponding parts are designated by like numerals and their description is omitted.

When the molten salt battery device 1 is operating, the temperature in each molten salt battery unit 3 is maintained at a temperature at which the molten salt serving as electrolyte is melted so that the molten salt battery cell 31 operates stably. The molten salt battery units 3, 3 . . . are charged and discharged through the receive/provide circuit 42. After the molten salt battery device 1 is stopped, the temperature of the molten salt battery units 3, 3 . . . falls to room temperature and hence the molten salt battery units 3, 3 . . . become not allowed to operate.

When the molten salt battery device 1 is to be started from a stopped state, in accordance with the start instruction input to the signal receiving unit 45, the control unit 44 causes the receive/provide circuit 42 and the electric power supplying circuit 43 to supply electric power from the external electric power source 47 to one molten salt battery unit 3. The molten salt battery unit 3 to which the electric power has been supplied from the external electric power source 47 is heated by the heaters 32, 32 . . . so that the molten salt in the molten salt battery cells 31, 31 . . . is melted into electrolytic solution, and hence the molten salt battery unit 3 is allowed to operate. Then, the control unit 44 causes the allowed-to-operate molten salt battery unit 3 to supply electric power to the other molten salt battery units 3, 3 . . . . The other molten salt battery units 3, 3 . . . are heated and thereby allowed to operate. Then, at the stage that all molten salt battery units 3 have become allowed to operate, startup of the molten salt battery device 1 is completed. After that, the control unit 44 causes the molten salt battery units 3, 3 . . . to be charged and discharged and causes the receive/provide circuit 42 to receive and provide electric power.

As described above in detail, in the present embodiment, in the molten salt battery device 1, one molten salt battery unit 3 is heated with the electric power from the external electric power source 47. Then, the remaining molten salt battery units 3, 3 . . . are heated with the electric power from the one molten salt battery unit 3 having become allowed to operate. The electric power from the external electric power source 47 heats the one molten salt battery unit 3 alone. Thus, energy consumption necessary for startup of the molten salt battery device 1 is allowed to be reduced. Further, similarly to Embodiments 1 and 2, the time necessary for heating the molten salt battery units 3, 3 . . . is allowed to be reduced and hence the warm-up time necessary for startup of the molten salt battery device 1 is allowed to be reduced.

Here, the molten salt battery device 1 may be in a mode adjusting the number of target molten salt battery units 3, 3 . . . to which electric power is to be supplied from the allowed-to-operate one molten salt battery unit 3 in accordance with the electric power demand. Further, the molten salt battery device 1 may be in a mode that each of the molten salt battery units 3, 3 . . . supplies electric power in a chained manner. Further, the molten salt battery device 1 may be in a mode that startup is performed at the stage that the one molten salt battery unit 3 has become allowed to operate. Further, a mode may be employed that electric power is supplied from the external electric power source 47 to the plurality of molten salt battery units 3. Further, the molten salt battery device 1 may be in a mode that the external electric power source 47 is connected directly to one molten salt battery unit 3.

Further, the above-mentioned Embodiments 1 to 3 have been described for a mode that the operation of the molten salt battery is controlled by the unit of molten salt battery unit 3. Instead, the molten salt battery device 1 may be in a mode that the operation of the molten salt battery is controlled by the unit of molten salt battery cell 31. In the molten salt battery device 1 in this mode, among the plurality of molten salt battery cells 31, 31 . . . , first, electric power is supplied to the heaters 32 for heating a part of the molten salt battery cells 31. Then, after the part of the molten salt battery cells 31 become allowed to operate, electric power is supplied from the molten salt battery cells 31 having become allowed to operate to the heaters 32, 32 . . . heating the other molten salt battery cells 31, 31 . . . . At the stage that the plurality of molten salt battery cells 31, 31 . . . have become allowed to operate, startup of the molten salt battery device 1 is completed. Also in this mode, energy consumption necessary for startup of the molten salt battery device 1 is allowed to be reduced and the warm-up time necessary for startup of the molten salt battery device 1 is allowed to be reduced. The embodiments disclosed here should be regarded as illustrative and not restrictive at all points. The scope of the present invention is defined by the claims and not by the description given above. Any changes falling within the scope of the claims or having equivalent meanings should be regarded as being included.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1.-9. (canceled)

10. A molten salt battery device, comprising:
a plurality of molten salt batteries operating in a state that molten salt serving as electrolyte is melted at a temperature higher than room temperature;
heaters each provided in each of the plurality of molten salt batteries;
an electric power source for supplying electric power at room temperature to the heaters provided in a part of the plurality of molten salt batteries; and
an electric power supplying unit for supplying electric power from the part of the plurality of molten salt batteries, to the heaters provided in another part of the plurality of molten salt batteries.

11. The molten salt battery device according to claim 10,
wherein the electric power supplying unit supplies electric power in a chained manner from the molten salt battery heated by the heaters to which electric power is supplied, to the heaters provided in another part of the plurality of molten salt batteries.

12. The molten salt battery device according to claim 10,
wherein the electric power supplying unit includes
an adjusting unit for adjusting the number of heaters to which electric power is to be supplied.

13. The molten salt battery device according to claim 12, further comprising:
an electric power providing unit for providing the outside with electric power from a part or all of the plurality of molten salt batteries; and
a receiving unit for receiving information indicating demand for electric power to be provided to the outside by the electric power providing unit,
wherein the adjusting unit adjusts the number of heaters to which electric power is to be supplied, in accordance with the information.

14. The molten salt battery device according to claim 10, further comprising:
a first electric power providing unit for providing the outside with electric power from a part or all of the plurality of molten salt batteries; and
a second electric power providing unit for providing the outside with electric power from the electric power source.

15. The molten salt battery device according to claim 10,
wherein the electric power source is a rechargeable battery capable of operating at room temperature.

16. The molten salt battery device according to claim 10,
wherein the electric power source is a capacitor.

17. The molten salt battery device according to claim 15, further comprising:
a first charging unit for charging the electric power source with electric power supplied from the outside; and
a second charging unit for discharging the electric power source and thereby charging a part or all of the plurality of molten salt batteries with the electric power having been charged in the electric power source.

18. The molten salt battery device according to claim 16, further comprising:
a first charging unit for charging the electric power source with electric power supplied from the outside; and
a second charging unit for discharging the electric power source and thereby charging a part or all of the plurality of molten salt batteries with the electric power having been charged in the electric power source.

19. A control method for controlling a molten salt battery device comprising: a plurality of molten salt batteries operating in a state that molten salt serving as electrolyte is melted at a temperature higher than room temperature; heaters each heating each molten salt battery; and an electric power source capable of operating at room temperature, comprising the steps of:
supplying electric power from the electric power source to the heaters heating a part of the plurality of molten salt batteries in a state that a temperature of the plurality of molten salt batteries is at room temperature; and
supplying electric power from the molten salt battery which has been heated by the heaters so that the molten salt has been melted to the heaters heating another part of the plurality of molten salt batteries.

20. The control method for molten salt battery device according to claim 19, further comprising the steps of:
receiving information indicating demand for electric power to be provided from the molten salt battery device to the outside; and
adjusting the number of molten salt batteries in which electric power is to be supplied to the heaters among the plurality of molten salt batteries, in accordance with the information.
